(19) United States
(12) Patent Application Publication
(10) Pub. No.: US 2025/0287176 A1
(43) Pub. Date: Sep. 11, 2025

(54) USING ON-BODY MICROPHONE TO IMPROVE USER INTERACTION WITH SMART DEVICES

(71) Applicant: HUAWEI TECHNOLOGIES CO., LTD., Shenzhen (CN)

(72) Inventors: Qiang XU, Kanata (CA); Ting LI, Shenzhen (CN); Zhe LIU, Kanata (CA); Chenhe LI, Kanata (CA); Tianyu ZHANG, Kanata (CA)

(73) Assignee: HUAWEI TECHNOLOGIES CO., LTD., Shenzhen (CN)

(21) Appl. No.: 19/215,190

(22) Filed: May 21, 2025

Related U.S. Application Data
(63) Continuation of application No. PCT/CN2022/143796, filed on Dec. 30, 2022.

(51) Int. Cl. H04S 7/00; H04S 3/00

(52) U.S. Cl. CPC H04S 7/307; H04S 3/008; H04S 2400/01; H04S 2400/13; H04S 2400/15

(57) ABSTRACT

Methods, devices, and processor-readable media for adjusting one or both of a listening and talking experience, including processing a user device audio signal representing a sound segment received at a microphone of an on-body user device of a user, wherein the sound segment is propagated as an acoustic wave between a smart device and the user and performing an action based on the processing.

### RELATED APPLICATION DATA

The present disclosure is a continuation of PCT Application No. PCT/CN2022/143796, filed on Dec. 30, 2022, entitled “USING ON-BODY MICROPHONE TO IMPROVE USER INTERACTION WITH SMART DEVICES”, the disclosure of which is hereby incorporated by reference in its entirety.

### FIELD

The present application generally relates methods, systems and computer media related to using an on-body microphone to improve user interaction with smart devices.

### BACKGROUND

The concept of a “Smart Home” that includes several computer-enabled smart devices connected to a wireless home network has been popular for several years. Examples of common smart devices that can be included in a smart home environment include smart TVs, virtual assistant-enabled smart speakers, smart lights, smart electrical switches and smart appliances such as smart fridges, which support audio notifications and voice commands.

Core experiences for users in a Smart Home environment include “Listen” and “Talk” experiences. As used here, the “Listen” experience can refer to the consumption and enjoyment of a user of the audio content provided by smart home devices; the “Talk” experience can refer to voice inputs provided by a user to smart home devices, which for example can include audio commands to such devices or the use of such devices as a communication intermediary between the user and other users, including their family or friends. Such experiences are quite important for the Smart Home environment because Smart Home devices are typically equipped with built-in microphones and speakers, which allow voice-based interaction.

Existing smart home devices have a number of operational shortfalls in the context of “Listen” and “Talk” experiences. In the case of the “Listen” experience, output audio settings (including volume and sound effect settings) are typically pre-defined at pre-set levels for each smart device such that a user must manually adjust the settings to make changes. Furthermore, even if a user wants to adjust these audio settings (e.g., through a control panel on the smart device, through a connected smartphone interface, or through a smart device remote control unit), they can only set the audio settings for the current audio environment that they are in, which is a factor of the specific region the user is physically located in and the current background noise conditions of that location. Once the current audio environment changes (due to one or both of user movement from a region or a change in background noise), the user selected audio settings may be imperfect for the user's new audio environment. Moreover, as there are normally multiple users in a smart home environment, and each user may have their own preference for the sound settings. Therefore when user starts using a smart device (e.g., a smart TV or smart speaker) after another user, they may find the sound settings are far from their preference.

In the case of the “Talk” experience, smart devices need to receive and detect users' voices to support voice interaction, and the threshold for voice reception (or the gain of the smart device microphone) is also pre-set or defined by the manufacturers. The location of a user and ambient noise can both impact the “Talk” experience, requiring a user to change their tone and voice in order for the smart device to recognize and understand their voice.

Solutions have been proposed to improve the smart home experience. Such solutions can, for example, be configured to recognize the location, movement direction, and identity of users present in a smart home environment. Two of these solutions include (i) using camera and computer vision techniques, and (ii) using laser and radar techniques.

Regarding solutions that are based on camera and computer vision techniques, such solution rely on smart devices equipped with built-in cameras for collecting visual light images and/or infrared light images. Through processing and analyzing these images, information about a surrounding environment the device can be deduced, including the presence of objects and/or users around the device and the distances between them. This image based information can be used for adjusting sound-based interaction. For example, the CMU-BC1 BRAVIA CAM™ by Sony™ has a feature called Ambient Optimization Pro that controls aspects of a smart TV sound output based on where a user is a room and how far the user is from the TV. Based on user position, left and right sound bounce will be automatically.

However, image based solutions can raise privacy concerns for some users. To achieve the high accuracy of detection, the system has to have an always-on camera, and an always-on camera can over-collect information, making users feel uncomfortable. This discomfort can be enhanced by fears of a possible hacking of the camera. As a result, many users prefer to keep the lens of smart device cameras covered unless they specifically require the camera such as for a video conference session. In addition to security issues, many smart device are not equipped with cameras and thus camera based solutions are not ubiquitous. Further, cameras must be aimed to capture a relevant field-of-view direction that includes the user in order to provide user-location-based functionality.

In the case of Lidar or radar based solutions to detect user distance and location, smart devices such as smart cleaning robots are able to construct a map of their environment and then perform real-time comparisons to detect obstacles. Although Lidar and radar sensors are capable of producing accurate results, they are expensive and can be relatively large. In addition, the energy consumption of Lidar or radar sensors is relatively high. For devices such as robots with specific usage purposes, the tradeoff between accuracy, cost and energy consumption can be acceptable. However, Lidar or radar based solutions may be economically or technically impractical for many types of smart devices.

Accordingly, there is a need for methods and systems that can provide an effective and efficient user-specific “Listen” and “Talk” experiences when it comes to sound in a smart-home environment.

### SUMMARY

The present disclosure describes methods and devices for providing one or both of enhanced or both of a listen and a talk experience in a smart environment by capturing audio data of a sound using a microphone of an on-body user device.

According to example aspects an automated method for enhancing one or both of a listen and a talk experience is disclosed. The method includes: processing a user device audio signal representing a sound segment received at a microphone of an on-body user device of a user, wherein the sound segment is propagated as an acoustic wave between a smart device and the user; and performing an action based on the processing.

In some example aspects, the sound segment is generated by one or more speakers of the smart device and propagates from the one or more speakers to the user.

In some examples of one more of the preceding aspects, processing the user device audio signal comprises extracting information about one or more sound properties of the sound segment from the user device audio signal and performing the action comprises causing an adjustment of the one or more sound properties for future sounds generated by the one or more speakers.

In some examples of one more of the preceding aspects, the one or more sound properties includes a volume.

In some examples of one more of the preceding aspects, the one or more sound properties includes a frequency equalization.

In some examples of one more of the preceding aspects, the one or more sound properties includes a relative balancing of multiple sound channels.

In some examples of one more of the preceding aspects, the one or more sound properties includes a relative time delay between multiple sound channels.

In some examples of one more of the preceding aspects, extracting information about one or more sound properties of the sound segment comprises comparing a reference audio signal used to generate the sound segment with the user device audio signal.

In some examples of one more of the preceding aspects, the method includes receiving by the smart device, through a wireless network, a transmitted copy of the user device audio signal, wherein processing the user device audio signal and performing the action are each performed by a processor system of the smart device.

In some examples of one more of the preceding aspects, the method includes sending by the smart device, through the wireless network, a message for the on-body user device requesting the on-body user device to record the sound segment to generate the user device audio signal.

In some examples of one more of the preceding aspects, the method includes generating, by the on-body user device, the user device audio signal, wherein processing the user device audio signal and performing the action are each performed by a processor system of the on-body user device and performing the action comprises causing an action request message to be sent through a wireless network communication link for the smart device.

In some examples of one more of the preceding aspects, the sound segment comprises a frequency sweep.

In some examples of one more of the preceding aspects, processing the user device audio signal comprises determining based on one or more parameters extracted from the user device audio signal when an unsafe listening experience exists for the user, and performing the action comprises, upon determining the unsafe listening experience exists, performing one or more actions to end the unsafe listening experience, including one or more of: causing a reduction in sound volume; adjusting a sound frequency equalization; causing sound to stop being generated; causing a message about the unsafe listening experience to be displayed on a display screen; and causing a message about the unsafe listening experience to be transmitted to a further device.

In some examples of one more of the preceding aspects, the method includes storing user device specific settings for the on-body user device and a plurality of further user devices, wherein performing the action is further based on the user device specific settings stored in respect of the on-body user device.

In some examples of one more of the preceding aspects, performing the action comprises causing one or both of a listening experience and a talking experience of the user to be automatically adjusted without requiring user action to effect the adjustment.

In some examples of one more of the preceding aspects, the sound segment originates from a mouth of the user and propagates from the user to a microphone of the smart device, and the method includes: generating, by the smart device, a local smart device audio signal representing the sound segment as received at the microphone of the smart device; receiving by the smart device, through a wireless network, a transmitted copy of the user device audio signal; and processing the local smart device audio signal in combination with processing the user device audio signal; wherein the action comprises generating a final audio signal based on the combined processing of the local smart device audio signal and the user device audio signal.

In some examples of one more of the preceding aspects, the smart device comprises one of a smart TV, an interactive smart speaker, a smart appliance, a smart sound system, and the on-body user device comprises one of a smart watch, a fitness tracker, smart glasses, a headset, an earphone, smart clothes and a hand-held mobile device.

In some aspects, the present disclosure describes a non-transitory processor-readable medium having machine-executable instructions stored thereon which, when executed by a processor device, cause the processor device to perform any of the methods described above.

In some aspects, the present disclosure describes a non-transitory processor-readable medium having instructions tangibly stored thereon. The instructions, when executed by a processor device, cause the processor device to perform any of the methods described above.

The examples disclosed herein may provide various advantages. The disclosed solutions can, in some scenarios, provide users with optimized experience without users' manual operation of individual smart devices that are present in the environment. The disclosed examples provide a solution by using the microphone of an on-body user device to enhance the user experience. Such a solution does not require dedicated hardware such as radar or Lidar systems to operate, and can be less intrusive than a video capture based solution.

### BRIEF DESCRIPTION OF THE DRAWINGS

Reference will now be made, by way of example, to the accompanying drawings which show example embodiments of the present application, and in which:

FIG. 1 is a block diagram illustrating an example of a smart home environment to which example embodiments of methods and systems of the present disclosure can be applied;

FIG. 2 is a block diagram of an illustrative example of a smart device that can be used to implement one or more of the smart devices included in the smart home environment of FIG. 1;

FIG. 3 is a flow diagram showing operations performed by a first smart device and an on-body user device to adjust a user listening experience, according to an example embodiment;

FIG. 4 is a flow diagram showing operations performed by a first smart device and an on-body user device to adjust a user listening experience, according to a further example embodiment;

FIG. 5 is a flow diagram showing operations performed by a first smart device and an on-body user device to adjust a user listening experience, according to a further example embodiment; and

FIG. 6 is a flow diagram showing operations performed by a first smart device and an on-body user device to adjust a user talking experience, according to a further example embodiment.

Similar reference numerals may have been used in different figures to denote similar components.

### DESCRIPTION OF EXAMPLE EMBODIMENTS

The present disclosure describes methods and devices for providing enhanced “Listen” and “Talk” experiences in a smart-home environment by recording sound using a microphone of on-body user device to provide a corresponding audio signal that can be processed to determine actions that can be performed to provide enhanced user experiences.

As used in the disclosure, sound is a vibration that propagates as an acoustic wave, through a transmission medium such as air. Human perceptible acoustic waves fall within the audio frequency range, between about 20 Hz and 20 kHz.

As used in this disclosure, an audio signal is a representation of sound. Examples of audio signals include analog audio signals and digital audio signals, which can for example be transmitted using electromagnetic signals or optical signals. A recorded or stored audio signal refers to an audio signal that is stored using a storage medium for future retrieval.

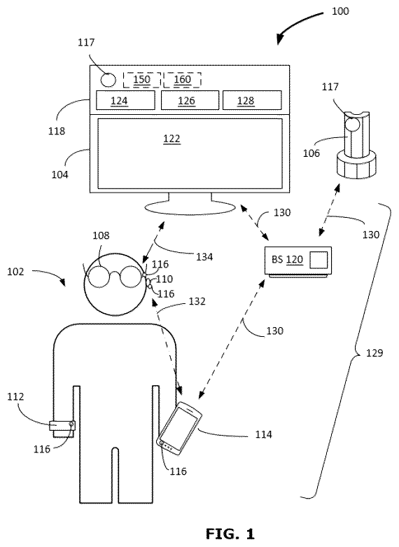

FIG. 1 is a block diagram illustrating an example of a smart home environment 100 to which example embodiments of methods and systems of the present disclosure can be applied. The environment 100 includes a plurality of smart devices. As used here, smart device can refer to a processor-enabled device that can interact with a human user (e.g. user 102) and interact with other electronic devices (e.g., other smart devices) via one or more wireless network protocols (e.g., Bluetooth™, Zignee™, near-field communication, wireless local area network such as WiFi™ or LiFi™, and/or wide area networks such as LTE, 5G and 6G). The smart devices in smart home environment 100 can for example include one or more static smart devices that are generally in a fixed location when in use, including for example a smart TV 104 and an interactive smart speaker 106. The environment 100 also includes one or more smart devices that are often mobile when in use, for example a smart vacuum (not shown) and wearable or on-body user devices such as smart glasses 108, a smart earphone 110 (or headset), and a smart watch 112. As used herein, on-body user device refers to a smart device that is intended to be commonly attached to, worn by, or carried by a human user 102. A mobile smart phone 114 can function as an on-body device when it is held by a user 102 or fixed to the user 102 by an arm band or a belt holster or belt clip.

Other non-limiting examples of static smart devices that could be included in the environment 100 can include, among other things, smart lights, smart electrical switches, smart controllers, and smart appliances such as smart fridges. On-body user devices can include any type of smart device that a user wears or carries on their body. Other non-limiting examples of on-body user devices can include smart cloths, smart fitness trackers, and smart wearable fall detection devices, among other things.

In the illustrated example, smart TV 104 has a display screen 122 and a sound system 118 that includes one or more audio signal to sound transducers (e.g., speakers 124, 126 and 128). The sound system 118 can, for example be integrated into the housing of smart TV 104. In alternative example, the sound system 118 can be a further smart device that includes one or more components housed separately from the smart TV 104, but is coupled to receive audio signals from the TV to generate sounds for consumption by user 102. In the illustrated example, sound system 118 may for example be a multi-channel system that generates multiple output directional sound channels using respective speakers. For example, speaker 124 can output sound corresponding to a left audio channel signal, speaker 126 can output sound corresponding to a center audio channel signal, speaker 128 can output sound corresponding to a right audio channel signal.

In the illustrated example, the sound system 118 includes a sound controller 150 that processes an input audio signal to provide respective audio channel signals for each of the sound channel specific speakers 124, 126 and 128. A number of properties of the sound generated by speakers 124, 126 and 128 sound system 118 can be controlled by the sound controller 150. For example, these sound properties can include one or more of: volume; equalization between frequency bands of the acoustic waves that collectively form the sound; balance and fade between the multiple sound channels; relative delay between the sound channels; and special effects applied to the sound.

In the illustrated examples, one or more of the smart devices included in the smart home environment 100 include built-in or associated microphones. For example, in the case of on-body user devices, smart glasses 108, earphones 110, smart watch 112 and smart phone 114 can each include an integrated microphone 116. Static smart devices such as the smart TV 104 and smart speaker 106 can also include microphones 117.

The microphones 116 associated with on-body user devices can be used to capture a representation of the sound experience of user 102 within the smart home environment 100. In most scenarios, the closer that a microphone 116 is to the ears of the user 102, the closer the sound captured by such a microphone will be to the user's actual sound experience. For example, an audio signal representation of a sound segment recorded by microphone 116 of earphone 110 or smart glasses 108 may, in some scenarios, be more representative of the user's sound experience than that of a wrist mounted or hand carried device.

The smart devices included in smart home environment 100 are able to communicate through a local or home wireless network 129 that can include one or more wireless networks that use respective wireless protocols. For example, in some embodiments one or more of the on-body user devices may be enabled to exchange electronic signals with the smart TV 104 and smart speaker 106 using a wireless local area network (e.g., a Wi-Fi Network™) that includes a base station 120. Base station 120 establishes respective communication links 130 with multiple respective smart devices and relays messages between these devices. In some examples, direct peer-to-peer wireless networks can be established using the Bluetooth™ protocol or Wi-Fi™ ad-hoc protocol, illustrated in FIG. 1 by communications links 132 and 134, for example. In some examples, communication channels between smart devices may be established using a combination of network protocols. For example, earphone 110 may establish a Bluetooth™ peer-to-peer connection with smart device 114, which in turn communicates with smart TV 104 via base station 120 using Wi-Fi communication links 130.

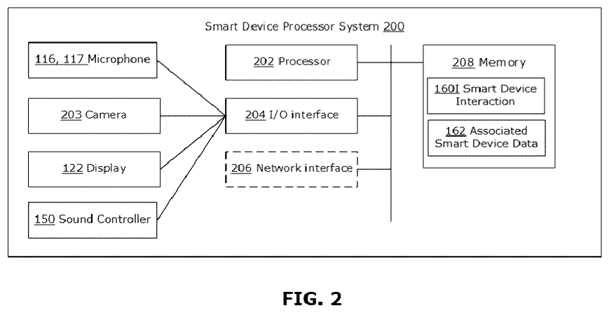

As noted above, smart devices of smart home environment 100 are processor-enabled devices. FIG. 2 shows a block diagram of a representative processor system 200 that can be used to implement one or more of the respective smart devices (e.g., smart TV 104, sound system 118, smart speaker 106, smart glasses 108, earphones 110, smart watch 112, and smart phone 114) of smart home environment 100. Although an example embodiment of the processor system 200 is shown and discussed below, other embodiments may be used to implement examples disclosed herein, which may include components different from those shown. Although FIG. 2 shows a single instance of each component of the processor system 200, there may be multiple instances of each component shown.

The processor system 200 includes one or more processors 202, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 202 may collectively be referred to as a “processor device”. The processor system 200 also includes one or more input/output (I/O) interfaces 204, which interfaces with input devices (e.g., camera 203, microphone 116 or 117) and output devices (e.g., display 122 and sound controller 150). The processor system 200 may include other input devices (e.g., buttons, knobs, touchscreen, etc.) and other output devices (e.g., a diagnostic port enabling data input and output).

The processor system 200 includes one or more network interfaces 206 communication with the wireless network 129 of smart home environment 100, including, for example, one or more interfaces for supporting wireless communication links 130, 132 or 134.

The processor system 200 includes one or more memories 208, which may include a volatile or non-volatile memory (e.g., a flash memory, a random access memory (RAM), and/or a read-only memory (ROM)). The non-transitory memory(ies) 208 may store instructions for execution by the processor(s) 202, such as to carry out examples described in the present disclosure. The memory(ies) 208 may include other software instructions, such as for implementing an operating system and other applications/functions. In the illustrated example, the memory 208 can include software instructions 160I for implementing a smart device interaction module on the smart device. In some examples, the software instructions 160I can be integrated into instructions for implementing a device operating system that supports interconnection between smart devices and the components of such devices, including, for example the Harmony Distributive OS™ available from Huawei™.

In some examples, the memory 208 may store associated smart device data 162 that includes the identities (e.g., device IDs) of other smart devices that are known to the smart device and preferred settings associated with those other devices.

In some examples, the processor system 200 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the processor system 200) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the processor system 200 may communicate with each other via a bus, for example.

Referring again to FIG. 1, the sound controller 150 of the sound system 118 of smart TV 104 can have one or more user interface controls that enable user control of output sound properties (e.g., volume; equalization between frequency bands of the acoustic waves that collectively form the sound; balance and fade between the multiple sound channels; relative delay between the sound channels; and special effects applied to the sound). Further, in the illustrated example, the sound system 118 includes a smart device interaction module 160. As used here, a “module” can refer to a combination of a hardware processing circuit (e.g. processor 202) and machine-readable instructions (software (e.g., smart device interaction instructions 160I) and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

The smart device interaction module 160 is configured to provide control signals to the sound controller 150 to cause the sound controller 150 to adjust one or more of the output sound properties. Example embodiments are described herein whereby the sound properties are dynamically and automatically adjusted based on the presence and location of the user 102 in the smart home environment 201. In particular, a sound experience of the user 102 can be optimized by using the microphone 116 of one or more of the on-body user devices (e.g., smart glasses 108, earphones 110, smart watch 112 and/or smart phone 114) associated with the user 102 to monitor the sound experience of the user 102 and provide feedback to the smart device interaction module 160.

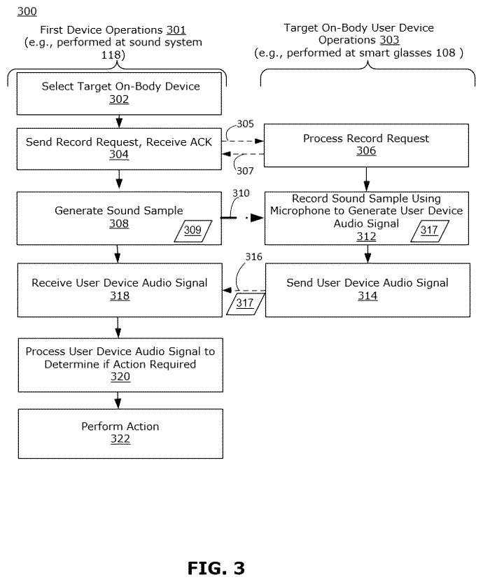

In this regard, FIG. 3 is a flow diagram showing operations 300 performed by a first smart device (first device operations 301) and an on-body user device (target on-body user device operations 303) to adjust a user listening experience, according to a first example embodiment. For illustrative purposes, operations 300 will be explained in the context of the sound system 118 of smart TV 104 functioning as the first smart device and smart glasses 108 functioning as the target on-body user device. Each of the sound system 118 and smart glasses 108 can have a respective smart device processor system such as smart device processor system 200 implementing a respective smart device interaction module 160 that configures the sound system 118 and smart glasses 108 to each respectively perform first device operations 301 and target on-body user device operations 303.

In an example embodiment, a plurality of smart devices are known to (e.g., pre-registered with) the smart device interaction module of the 160 of the sound system 118, and information for each of these devices is stored as associated smart device data. By way of example, Table 1 below is illustrative of the type of associated smart device data 162 that may be stored.

TABLE 1
Associated Smart Device Data

| | | | On- | Sound Property Settings | | | | |
|---|---|---|---|---|---|---|---|---|
| Device | User | Connect | board | | | Channel | Channel | |
| ID | ID | Status | Mic | Volume | Equalization | Balance | Delay | SFX |

| | | | |
|---|---|---|---|
| SG 108 | 102 | YES | Y |
| EP 110 | 102 | YES | Y |
| SW 112 | 102 | YES | Y |
| SP 114 | 102 | YES | Y |
| . | | | |
| . | | | |
| . | | | |

As shown in Table 1, the associated smart device data 162 can, for example include: a device ID for all pre-registered on-body user devices (e.g., smart glasses (SG) 108; earphone (EP) 110; smart watch (SW) 112; smart phone (SP) 114); (ii) a user ID linked to the individual devices, allowing user devices having a common user to be identified; (iii) a network connection status indicating if a wireless network communications link is currently active (e.g., connected) or inactive (e.g., not connected) between the sound system 118 and the respective devices; (iv) an indication of whether the associated device has an on-board microphone; and (v) a list of output sound property settings for each of the associated devices (which in turn correspond to the sound properties that are presented to the device user). In some examples where a common user ID is associated with a set devices, then the output sound characteristic settings for all of those devices may be set to the same values.

In some examples, the output sound property settings for the associated devices may be pre-set to default values. In some examples those default values may be device or user specific, based for example on the most recent settings associated with that particular devices ID or User ID. In some examples the default settings may be set to factory settings or user pre-set settings.

In the illustrated example, the operations 300 can be triggered by the occurrence of a trigger event from a set of one or more defined trigger events. For example, these trigger events could include: the sound system 118 is activated to start playing audio; the sound system output system switches from one audio program to another (e.g., corresponding to a video channel or program streaming change by smart TV 104); detection of a newly active network connection with an on-body user device; and a user input through a user interface. In some examples, operations 300 can be performed periodically when sound system 118 is generating a sound output as part of its normal operation. For example, during its normal operation, the sound system 118 can be outputting a multi-channel sound sequence (e.g., front right, front center and front left sound channels of a movie sound track) that corresponds to a video output (e.g., a movie) that is being displayed on video display 122 of the smart TV 104.

As indicated at Block 302, as part of first device operations 302, the smart device interaction module 160 of the sound system 118 identifies the presence of one or more microphone equipped on-body user devices within a listening range of the sound system 118. In an example embodiment, the smart device interaction module 160 of sound system 118 is configured to continuously maintain associated smart device data 162, including for example the data shown in above Table 1. Based on such data, the sound system 118 is able to identify what microphone equipped on-body user device(s) it currently has an active local wireless network connection in place with. The presence or absence of a network connection can function as an indication of the presence of absence of one or more associated target on-body devices within a listening range of the sound system 118. In some examples, the type of network connection may be used to determine device presence; for example, a direct peer-to-peer network communication link 134 (for example Bluetooth™) may be considered to be indicative of the presence of an on-body user device, while an indirect connection view a WiFi base station 120 may not be considered to be indicative of the presence of an on-body user device within a listening range of the sound system 118.

In some examples, sound system 118 may determine that there are multiple microphone equipped on-body user devices within a listening range (e.g., smart glasses 108; earphone 110; smart watch 112; and smart phone 114. In such scenarios, the sound system 118 may be configured to select one such on-body user device as a representative target on-body user device based on a defined hierarchy of such devices as a means for representing a user listening experience. For example, head-mounted on-body user devices such as smart glasses or earphone 110 may be ranked as 1^{st} choice and 2^{nd} choice, respectively, do to user ear proximity, with on-body user devices that are further from the user's ears such as smart watch 112 and smart phone 114, being ranked as 3^{rd} choice and 4th choice, respectively. In some examples, the user ID associated with the connected on-body user devices can also be used to rank the on-body user devices. For example user 102 may be pre-defined as a higher priority user than a further user that has an on-body user device that is also within a listening range of the sound system 118. Thus, one or a combination of an on-body user device type and a user ID associated with the on-body user device can be sued to determine a relative ranking of the on-body user devices that are determined to be within a listening range of the sound system 118.

Sound system 118 selects one or more of the connected microphone equipped user devices as a target on-body user devices. In some examples where ranking is applied, only the 1^{st} ranked on-body user device is identified as a target on-body device for further of the operations 300. In some examples, multiple on-body user devices can be selected as target on-body devices.

The scenario will now be described for the case where a single on-body user device has been identified in Block 302 as the target on-body device, namely smart glasses 108. As indicated in Block 304, the sound system 118 is configured to send a wireless message (e.g., a “record request”) for the smart glasses 108. The record request is sent as an RF signal 605 using the smart home environment wireless network 129 (e.g., using a peer-to-peer communication link 134 or a WiFi communication link 130, or a combination thereof).

In some examples, as indicated at Block 306 the target on-body user device (e.g., smart glasses 108 in the illustrated example) is configured to receive the RF signal 305 and decode and process the record request message. In at least some examples, the smart glasses 108 will determine if it is able to perform the record request (e.g., determine that its on-board microphone 116 is available to perform the record request and not currently in use for a different function), and will send an wireless RF signal 307 via one or more communications links of wireless network 129 for sound system 118 that includes an indication that the smart glasses 108 are available (or not available) to perform the record request. In such scenarios, the sound system 118 will monitor for the acknowledgement (ACK) RF signal 307 from the smart glasses 108, and if the smart glasses 108 are determined to not be available to perform the request, return to Block 302 to select a different target on-body user device.

As indicated at Block 308, after sending the record request and determining that the smart glasses 110 are available to process the record request, the sound system 118 causes speakers 124, 126 and 128 to generate an acoustic wave sound segment 310 for a sound segment duration using a known set of sound properties (for example, using the sound properties specified in Table 1). In some examples, the sound segment 310 that is played may be a segment of an on-going audio output that is being played during a normal operation of the sound system 118 (e.g., the sound for a video program or music program that is currently being played). The sound system 118 can store an electronic version of reference audio signal 309 of the sound segment for future processing purposes.

In some examples, the sound segment 310 that is played may be a dedicated sound sample generated based on a stored custom reference audio signal 309 that has been created for the purpose of operations 300. For example, the sound segment 310 could be a sine sweep. A sine sweep is a sine function that gradually changes frequency over time. The sine sweep can also be called “sinusoidal sweep,” “frequency sweep”, or “chirp”, generated using the function x(t)=sin(2π(f0*t+ ((f1−f0)/2T)*t\hat{ }2)). For example, the sound frequency can be changed from f0 to f1 over the time T, where f0=20 Hz, f1=20000 Hz, and T=60 s. The frequency sweeping sound segment 310 can be played solely or mixed with other sounds, including sounds of a normal operation of the sound system 118. The sound samples can include channel specific sounds for output by each of the respective speakers 124,126 and 128.

As indicated at Block 312, upon receiving and acknowledging the record request message, the smart glasses 108 causes its embedded microphone 116 to be activated for a defined sound segment duration in order capture the sound segment 310. The microphone 116 converts received acoustic waves corresponding to the sound segment 310 into a user device audio signal 317 that can be recorded and electronically stored in memory. The user device audio signal 317 will include information that indicates one or more properties of the sound segment that has propagated from the sound system 118 to the user 102. In some examples, the defined sound segment duration may be specified in the record request message; in other examples, it may be a preset value known to smart glasses 108. In some cases, the target on-body user device (e.g. smart glasses 108) may include multiple microphones 116, in which cases multiple microphones may be activated for the sound segment duration for respectively recording the sound segment to generate recorded user device audio signal 317. It will be noted that in the illustrated example the on-body user device microphone 116 is only activated for the defined sound segment duration. This may help alleviate privacy concerns of users who do not want to be continually monitored.

As indicated at Block 314, the target on-body user device (e.g. smart glasses 108) then transmits an RF signal 316, embedded with a copy of the user device audio signal 317, through the wireless network 129. As indicated at Block 318, sound system 118 receives and decodes the RF signal 316 to retrieve and store a local copy of recorded user device audio signal 317.

As indicated in Block 320, the sound system 118 processes the recorded user device audio signal 317 to determine if any action should be taken such as adjusting the sound properties of the sound that is being generated by sound system 118. As noted above, the user device audio signal 317 will include information that indicates one or more properties of the sound segment that has propagated from the sound system 118 to the user 102. In some examples, the processing can include comparing parameters of the stored reference audio signal 309 with corresponding parameters of the recorded user device audio signal 317, thereby enabling properties of the propagated sound segment to be extracted. In some examples, the processing may be based on comparison of parameters of the recorded user device audio signal 317 with defined thresholds.

By way of example, the sound system 118 can be configured to determine if adjustments to sound volume is required by comparing sound magnitude parameters extracted from the stored reference audio signal 309 with those extracted from the recorded user device audio signal 317. If the magnitude parameters of the recorded user device audio signal 317 fall below a threshold level relative to the comparable magnitude parameters of stored reference audio signal 309, a determination may be made that a volume property of the sound generated by the sound system 118 needs to be increased. These magnitude parameters can also be considered on a channel by channel basis based on analysis of channel specific sound outputs of the respective speaker channels to determine if channel balance and fade property adjustments are required.

In the case of channel delay properties that can be provide an enhanced spatial audio experience, in at least some examples, a physical location of the user 102 relative to the sound system 118 can be deduced by detecting changes in the relative channel timing in the recorded user device audio signal 317 and the stored reference audio signal 309. For example, the timing of sounds generated by the respective front left, center and right speakers 124, 126 and 128 may be set based on an assumption that the user 102 is located front and center of the sound system 118. By comparing the relative time differences between channel specific sounds represented in the recorded user device audio signal 317 relative to those of the stored reference audio signal 309, actual variations between an intended and actual time-of-flight of the acoustic waves from speakers 124, 126 and 128 to the recording on-body microphone 116 can be determined. This information, which is indicative of the actual physical location of the user 102 relative to the sound system 118, can be used to compute adjustments to the channel delay properties of generated sounds in order to enhance the spatial audio experience of the user 102.

Regarding frequency band equalization properties, in some examples a frequency response (i.e., a range of frequencies or musical tones) of recorded user device audio signal 317 (which represents an actual frequency response) and the stored reference audio signal 309 (which can represent a desired frequency response) can be compared to determine differences between an actual response and a desired response and suitable equalization property adjustments calculated to minimize the difference.

As indicated in Block 322, in an example embodiment the actions determined in Block 320 are performed. For example, sound property adjustments that are computed by the smart device interaction module 160 of the sound system 118 are applied to control the sound controller 150 to effect the adjustments.

In some examples, the operations 300 may be repeated on an on-going periodic basis to provide continuing dynamic adjustments to the user listening experience. The operations 300 may be repeated with sufficient frequency to provide real-time adjustments that correspond to changes in the user's relative position relative to the sound system 118 and/or background noises.

In some examples, in Block 302 multiple on-body user devices may be selected as target on-body user devices. In such cases, the target on-body user device operations 303 may be performed independently at each of the selected target on-body user devices and the sound system 118 will receive respective recorded audio signals from each of the target on-body user devices for processing. Sound property adjustments can be computed based on the collective processing results.

In some examples the multiple target on-body user devices may be associated with multiple users, with each user having a different relative location to the sound system 118. Such a scenario may for example occur when several people are in a room using the smart TV for a video call. In multi-user scenarios, the sound system 118 can be configured to selectively optimize one of the sound properties. For example, the sound magnitude parameters of the respective recorded user device audio signals 317 can each be independently analyzed to ensure the sound volume property is sufficiently high to enable all of the users to hear the sounds output by the speakers 124, 126, 128 of the sound system 118. In at least some examples, the above described time-of-flight analysis can be performed to estimate the relative locations of individual users to the respective speakers 124, 126, 128, and the resulting data used to individually adjust the individual speaker volumes so as to provide the collective optimal sound volume for all of the participating users. Further, the inclusion of unique speaker channel sounds in the sound segment can enable the volume property magnitudes to be determined for each of the individual speakers 124, 126, 128 for each of the participating target on-body user devices. This data can be used to individually adjust the individual speaker volumes so as to provide the collective optimal sound volume for all of the participating users.

In some examples, the actions that are determined in Block 320 and performed in Block 322 can be or include actions other than sound property adjustments. For example, in some implementations processing of the recorded user device audio signal 317 may include comparing sound magnitude properties to one or more defined thresholds to determine if an unsafe listening experience (e.g., potentially ear damaging volume is occurring. In the event that an unsafe listening experience is detected, automated actions could include one or more of: displaying a volume adjustment suggestion on display 122; causing sound output to pause; sending an email or text notification to a defined contact (e.g., a parent) advising of the unsafe listening experience; and adjusting the output volume down to a lower level.

In some examples, the thresholds to determine if an unsafe listening experience exists could be stored as part of the associated smart device data 162 and could be user and/or user device specific thresholds. For example, a volume based threshold for an on-body user device associated with a child may be preset through a user interface to be lower than that for an on-body user device associated with a hearing impaired senior.

In some examples, the thresholds for detecting an unsafe listening experience could be based on frequency response properties of the recorded user device audio signal 317.

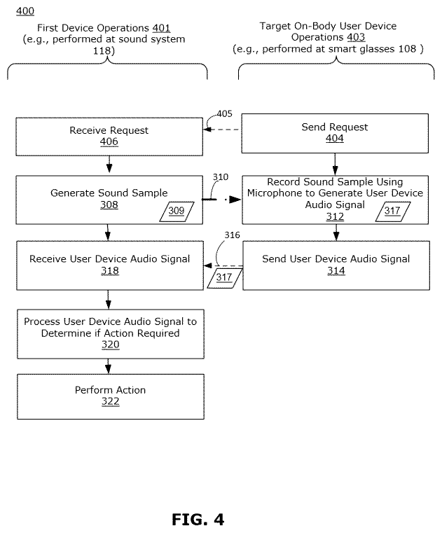

In the illustrated example, the sound system 118 selects the target on-body user device(s) to send a record request to. However, in some examples, an on-body user device may be used to initiate operations. By way of example, FIG. 4 illustrates a set of operations 400 that are the same as operations 300 with the exception of difference noted below. As indicated in Block 406, in the case of operations 400, the on-body user device (e.g., smart glasses 108) sends an RF signal 405 that includes a calibration request for sound system 118 via wireless network 129. The request may for example be initiated by an input by user 102 to the on body user device. For example, the user may issue a verbal instruction “Smart Glasses, calibrate Smart TV sound system output” that is picked up by the microphone 116 of smart glasses 108 and triggers the request. Upon receiving the request, the sound system 118 commences performing operations 401. Thereafter, the operations represented by Blocks 308 and onward in FIG. 4 can be identical to those described above in respect of FIG. 3.

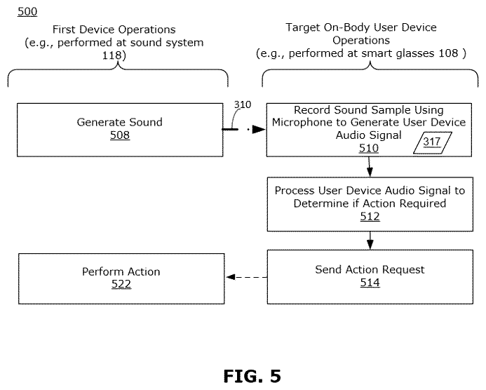

In some alternative examples, recorded user device audio signal 317 may not be transmitted to the sound system 118, and some or all of the processing operations associated with Block 320 may instead be performed at the target-on-body user device. In this regard, FIG. 5 illustrates operations 500 corresponding to an example embodiment where an on-body user device (e.g., smart glasses 108) are configured to periodically (or in response to a user input or other defined trigger event) activate its microphone 116 to capture a sound segment (Block 510) that has been generated by the sound system 118 during its normal operation (Block 508). The on-body user device may process the resulting user device audio signal 317 locally (Block 512) by comparing properties of the user device audio signal 317 to locally stored audio property thresholds to determine if any actions are required to adjust a listening experience of the user associated with the on-body user device. For example, sound magnitude properties of the user device audio signal 317 can be processed to determine if they exceed one or more maximum thresholds in which case a volume reduction action is required, or fall below one or more minimum thresholds, in which case an increase volume action is required. Based on the processing results, the on-body user device transmits an RF signal via network 129 requesting the required action (Block 514). In the example of FIG. 5, the sound system 118 receives and implements the requested action (Block 522), thereby enhancing the user's listening experience.

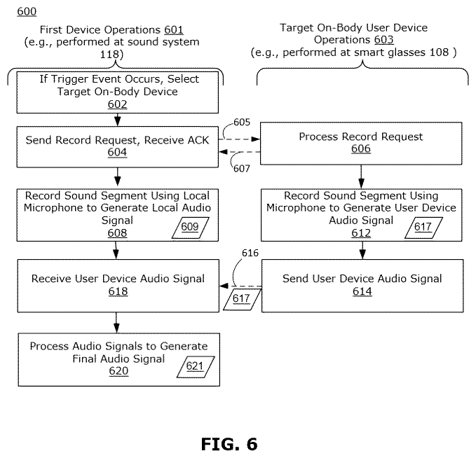

The above examples have focused on enhancing the user's listening experience. In some implementations the respective smart devices of smart home environment 100 can be configured to enhance a user's speaking or “talk” experience by selectively using audio signals that are generated at multiple device microphones for the same user generated sounds. In this regard, FIG. 6 illustrates a flow diagram showing operations 600 performed by a first smart device (first device operations 601) and an on-body user device (target on-body user device operations 303) to enhance a user's talk experience, according to a first example embodiment. For illustrative purposes, operations 600 will be explained in the context of sound system 118 functioning as the first smart device and smart glasses 108 functioning as the target on-body user device. In the illustrated example, sound system 118 includes an associated dedicated local microphone 116 for capturing sound within the local smart home environment. For example, sound system microphone 117 may be connected to an I/O interface 204 of the smart device processor system 200 of the sound system 118 by a wired or wireless communication link. Sound system microphone 117 can, for example, be integrated into a housing of the smart TV 104 (or a housing of the sound system 118, in the case where the sound system 118 has an independent housing), or may be a stand-alone microphone operatively connected to the sound system 118.

The sound system microphone 117 is configured to convert sound into an audio signal input for the sound system 118 for further processing. In some use scenarios, the sound can include a voice command or voice input that is intended to cause the smart device processor system 200 of the sound system 118 to perform an action based on the voice command or voice input. In such cases, the further processing includes converting the audio signal input into a computer actionable input. Examples of such voice commands or inputs can include, for example “Increase Volume”; “Change Channel; “Record this program”; “Video Call Bob Smith”; “Tell me the weather”, and the like. In other use scenarios, the sound can include voice and other audio range sounds that are part of a dialogue in which the smart device processor system 200 of the sound system 118 acts simply as an intermediary that transmits the audio signal input along to a further device. For example, in the context of an on-going video conference call, the sound captured by sound system microphone 117 is converted into an audio signal for transmission with a video signal over one or more networks to a counterpart video conference-call device for consumption by a further party to the call.

In each of the above cases, the input sound received at sound system microphone 117 is converted into a local audio signal. In example embodiments, the operations 600 can be triggered by one or more defined trigger events. In an illustrative example, the smart device processor system 200 of the sound system 118 is configured to monitor one or more sound properties of the local audio signal output by sound system microphone 117 and determine when one of more of those properties fails to meet a defined performance criteria. For example, determining if a performance criteria is met can be based on comparing a volume parameter extracted from the local audio signal to a defined threshold. Failure to meet the performance criteria can be indicative that the sound system microphone 117 is not sufficiently capturing the sound input being provided by a user 102. In an illustrative example, the failure of the sound properties of the local audio signal output to meet a defined performance criteria is a trigger event than causes the sound system 118 to commence operations 600. A purpose of operations 600 is to enable the sound system 118 to supplement the sound input it is receiving at its local microphone 117 with sound inputs captured by the respective microphones 116 of one or more of the on-body devices that are present in the smart home environment 100.

As indicated at Block 602, when a trigger event occurs, the smart device interaction module 160 of the sound system 118 is configured to identify and select one or more microphone equipped target on-body user devices within a speaking range of the sound system 118. This can be done in a similar manner as described above in respect of Block 302 to select a microphone equipped target on-body user device that is within a listening range.

The scenario will now be described for the case where a single on-body user device has been identified in Block 602 as the target on-body device, namely smart glasses 108. As indicated in Block 604, the sound system 118 is configured to send a wireless message (e.g., a “record request”) for the smart glasses 108. The record request is sent as a wireless electromagnetic (EM) radio frequency (RF) signal 305 using the smart home environment wireless network 129. For example, RF signal 305 could be sent using a peer-to-peer communication link 134 or a WiFi communication link 130, or a combination thereof (e.g., base station 120 can relay the record request message from sound system 118 to smart phone 114 which in turn uses a peer-to-peer link to relay the message to smart glasses 108).

In some examples, as indicated at Block 606 the target on-body user device (e.g., smart glasses 108 in the illustrated example) is configured to receive the RF signal 605 and decode and process the record request message. In at least some examples, the smart glasses 108 will determine if it is able to perform the record request (e.g., determine that its on-board microphone 116 is available to perform the record request and not currently in use for a different function), and will send an wireless RF signal 607 via one or more communications links of wireless network 129 for sound system 118 that includes an indication that the smart glasses 108 are available (or not available) to perform the record request. In such scenarios, the sound system 118 will monitor for the acknowledgement (ACK) RF signal 607 from the smart glasses 108, and if the smart glasses 108 are determined to not be available to perform the request, return to Block 602 to select a different target on-body user device.

As indicated at Block 608, the sound system 118 proceeds with using its local microphone 117 to capture sound input and generate a respective recorded local audio signal 609. In an example scenario, the sound input that is captured corresponds to a sound segment spoken by the user 102 that is wearing the smart glasses 108. Thus, the recorded local audio signal 609 will include properties of the sound segment as propagated from the user's mouth to the local microphone 117.

As indicated at Block 612, upon receiving and acknowledging the record request message, the smart glasses 108 causes its embedded microphone 116 to be activated to also capture the sound input. The microphone 116 converts received acoustic waves corresponding to the sound segment into a user device audio signal 617 that can be recorded and electronically stored in memory. In some cases, the target on-body user device (e.g. smart glasses 108) may include multiple microphones 116, in which cases multiple microphones may be activated for the sound segment duration for respectively recording the sound to generate recorded user device audio signal 617.

As indicated at Block 614, the target on-body user device (e.g. smart glasses 108) then transmits an RF signal 616, embedded with a representation of the user device audio signal 617, through the wireless network 129. As indicated at Block 618, sound system 118 receives and decodes the RF signal 616 to retrieve and store a local version of recorded user device audio signal 617.

As indicated in Block 620, the sound system 118 processes the user device audio signal 617 and the corresponding local audio signal 609 to extract information for generating a final audio signal 621. Known signal processing techniques for merging independently captured audio signals corresponding to the same input sound can be applied to provide a final audio signal 621 that can have enhanced qualities relative to one or both of the user device audio signal 617 and the corresponding local audio signal 609. The final audio signal 621 can then be used for the purpose intended for the local audio signal 609 (i.e. as a voice command or input, or for transmitting a representation of a dialog).

Accordingly, operations 600 can enhance the talking experience of user 102 as the sound system 118 works dynamically and automatically with the target-on-body user device (e.g., smart glasses 108) to compensate for a poor quality sound input at the microphone 117 of the sound system 118. In at least some use scenarios, an enhanced final audio signal 621 can be generated by the sound system 118 such that the user 102 is not required to change their speaking volume or to change their location to move closer to the microphone 117 of the sound system 118.

In some examples, multiple on-body user devices may be selected as target on-body user devices. In such cases, the target on-body user device operations 603 may be performed independently at each of the selected target on-body user devices and the sound system 118 will receive respective recorded user device audio signals 617 from each of the target on-body user devices for processing. The resulting final audio signal 621 can be a combination of audio data extracted from one or more of the user device audio signals 617 and the local audio signal 609. Such a system can be particularly useful when multiple users are using a common smart device (e.g., Smart TV sound system 118) for a joint video conference call.

Although certain operations are described above as being performed by the smart device processor systems 200 of specific smart devices, in alternative embodiments various operations may be performed or distributed partially or completely on other smart devices within the smart home environment 200.

It will be appreciated that the disclosed smart home environment 100 can, in some scenarios, provide users with optimized experience without users' manual operation of individual smart devices that are present in the environment. In overview, the present disclosure is directed resolving the existing problem that that in a smart home environment it can be difficult for participating smart devices to accurately determine what sounds a user is hearing or making. The disclosed embodiments provide a solution by using the microphone of an on-body user device to enhance the user experience. Given that these on-body microphones will typically be close to the user's ear and mouth, the recordings from these microphones can be used to capture the sound the user is hearing or making. These recorded audio signals can be used as the input for other smart devices to provide the user with intelligent services. In the case where the user is hearing the sound, the properties of the sound as propagated from the originating smart device to the user will be embedded in the recorded audio signal. In the case where the user is speaking the sound, the properties of the sound as propagated from the user to a local microphone of the smart device will be embedded in the audio signal that is recorded at the smart device, whereas the audio signal as recorded at the microphone of the on-body user device will embed the properties of the pre-propagated sound at its origin (e.g., the user's mouth).

In each of the listen and talk scenarios, one or more properties of a sound segment propagated between a smart device and a user can be determined based on an audio signal generated by a microphone of an on-body user device of the user. In the case of the listen scenario, the sound propagated between the smart device and the user is the sound that is generated by the output speakers of the smart device and captured by the microphone 116 of the on-body user device. In the case of the talk scenario, the sound propagated between the smart device and the user is in the opposite direction and is the sound that is generated by speaker's mouth and captured by the local microphone 117 of the smart device. In both cases, properties of the propagated sound can be extracted based on the audio signal generated by the microphone of the on-body user device. An action can be performed based on determining the one or more properties of the propagated sound.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

As used herein, statements that a second item is “based on” a first item can mean that characteristics of the second item are affected or determined at least in part by characteristics of the first item. The first item can be considered an input to an operation or calculation, or a series of operations or calculations that produces the second item as an output that is not independent from the first item.

1. An automated method comprising:
processing a user device audio signal representing a sound segment received at a microphone of an on-body user device of a user, wherein the sound segment is propagated as an acoustic wave between a smart device and the user; and
performing an action based on the processing.

2. The method of claim 1 wherein the sound segment is generated by one or more speakers of the smart device and propagates from the one or more speakers to the user.

3. The method of claim 2 wherein processing the user device audio signal comprises extracting information about one or more sound properties of the sound segment from the user device audio signal and performing the action comprises causing an adjustment of the one or more sound properties for future sounds generated by the one or more speakers.

4. The method of claim 3 wherein the one or more sound properties includes a volume.

5. The method of claim 3 wherein the one or more sound properties includes a frequency equalization.

6. The method of claim 3 wherein the one or more sound properties includes a relative balancing of multiple sound channels.

7. The method of claim 3 wherein the one or more sound properties includes a relative time delay between multiple sound channels.

8. The method of claim 3 wherein extracting information about one or more sound properties of the sound segment comprises comparing a reference audio signal used to generate the sound segment with the user device audio signal.

9. The method of claim 8 comprising:
receiving by the smart device, through a wireless network, a transmitted copy of the user device audio signal,
wherein processing the user device audio signal and performing the action are each performed by a processor system of the smart device.

10. The method of claim 1 comprising:
sending by the smart device, through the wireless network, a message for the on-body user device requesting the on-body user device to record the sound segment to generate the user device audio signal.

11. The method of claim 2 comprising generating, by the on-body user device, the user device audio signal, wherein processing the user device audio signal and performing the action are each performed by a processor system of the on-body user device and performing the action comprises causing an action request message to be sent through a wireless network communication link for the smart device.

12. The method of claim 1 wherein the sound segment comprises a frequency sweep.

13. The method of claim 1 wherein processing the user device audio signal comprises determining based on one or more parameters extracted from the user device audio signal when an unsafe listening experience exists for the user, and performing the action comprises, upon determining the unsafe listening experience exists, performing one or more actions to end the unsafe listening experience, including one or more of: causing a reduction in sound volume; adjusting a sound frequency equalization; causing sound to stop being generated; causing a message about the unsafe listening experience to be displayed on a display screen; and causing a message about the unsafe listening experience to be transmitted to a further device.

14. The method of claim 3 comprising storing user device specific settings for the on-body user device and a plurality of further user devices, wherein performing the action is further based on the user device specific settings stored in respect of the on-body user device.

15. The method of claim 1 wherein performing the action comprises causing one or both of a listening experience and a talking experience of the user to be automatically adjusted without requiring user action to effect the adjustment.

16. The method of claim 1 wherein the sound segment originates from a mouth of the user and propagates from the user to a microphone of the smart device, the method comprising:
generating, by the smart device, a local smart device audio signal representing the sound segment as received at the microphone of the smart device;
receiving by the smart device, through a wireless network, a transmitted copy of the user device audio signal;
processing the local smart device audio signal in combination with processing the user device audio signal;
wherein the action comprises generating a final audio signal based on the combined processing of the local smart device audio signal and the user device audio signal.

17. The method of any claim 1 wherein the smart device comprises one of a smart TV, an interactive smart speaker, a smart appliance, a smart sound system, and the on-body user device comprises one of a smart watch, a fitness tracker, smart glasses, a headset, an earphone, smart clothes and a hand-held mobile device.

18. A processor system comprising:
a processor; and
a memory storing machine-executable instructions thereon which, when executed by the processor, cause the processor system to:
process a user device audio signal representing a sound segment received at a microphone of an on-body user device of a user, wherein the sound segment is propagated as an acoustic wave between a smart device and the user; and
perform an action based on the processing.

19. A non-transitory processor-readable medium having machine-executable instructions stored thereon which, when executed by a processor, cause the processor to:
Process a user device audio signal representing a sound segment received at a microphone of an on-body user device of a user, wherein the sound segment is propagated as an acoustic wave between a smart device and the user; and
perform an action based on the processing.
